(19) United States
(12) Patent Application Publication
(10) Pub. No.: US 2026/0273997 A1
(43) Pub. Date: Sep. 17, 2026

(54) METHOD FOR FORMING THREE-DIMENSIONAL WOOD GRAIN ON BOARD SURFACE, RESULTING BOARD, AND APPLICATIONS

(71) Applicant: HANGZHOU PRINT FLOORING TECHNOLOGY CO., LTD., Hangzhou City (CN)

(72) Inventors: Guocui Yang, Hangzhou City (CN); Zhongshan Lei, Hangzhou City (CN); Mengde Deng, Hangzhou City (CN); Donghui Huang, Hangzhou City (CN); Fangbing Ao, Hangzhou City (CN); Feng Huang, Hangzhou City (CN)

(21) Appl. No.: 19/470,039

(22) PCT Filed: Mar. 1, 2024
(86) PCT No.: PCT/CN2024/079581

§ 371 Date: Sep. 27, 2025

(30) Foreign Application Priority Data
Mar. 31, 2023 (CN) 202310337402.X

(51) Int. Cl. B44F 9/02; B41F 19/02; B41M 3/06; B41M 7/00

(52) U.S. Cl. CPC B44F 9/02; B41F 19/02; B41M 3/06; B41M 7/0054

(57) ABSTRACT

A method for forming three-dimensional (3D) embossed wood grain on the surface of a panel, comprising at least the following steps: applying a resin solution onto at least a portion of an ink layer surface and curing it to form a wood grain base layer; covering at least a portion of the wood grain base layer surface with at least one layer of resin solution; applying an embossing liquid onto at least a portion of the resin surface along the wood grain pattern of the ink layer to form an embossing layer; curing the areas of the resin solution other than the embossing layer and then removing the embossing layer, thereby forming a three-dimensional wood grain layer on the surface of the wood grain base layer.

### TECHNICAL FIELD

The present invention relates to the field of surface structure preparation, particularly to a method for forming a three-dimensional wood grain on the surface of a board, as well as the resulting board containing the three-dimensional wood grain, the method for forming the board, and applications of the board.

### BACKGROUND ART

Currently, to achieve a texture similar to natural wood on the surface of engineered or non-wood boards, a two-dimensional planar wood grain image is typically formed on the board surface through printing or printing techniques, thereby visually satisfying people's visual demand for wood-like materials.

For example, patent Publication No. CN 101659073 B discloses a wood grain treatment process for the surface of a waterproof flooring substrate. This process involves printing a simulated wood grain on the surface of a wood-plastic composite floor, followed by adding a wear-resistant layer above the simulated wood grain, thereby protecting the wood grain pattern and maintaining the wood grain texture effect for a long time. However, such boards with only a two-dimensional planar image printed on the surface can no longer satisfy people's demand for pursuing a more authentic combination of visual sensation and tactile sensation.

Therefore, forming a three-dimensional wood grain on the board surface that corresponds to the two-dimensional planar image and has a tactile sensation closer to that of wood is a focus of widespread attention in this field currently.

In the prior art, to form a three-dimensional structure on the substrate surface, multiple different technical solutions have been proposed, and conventional methods typically include two types: additive stacking method and subtractive indentation method.

Taking the additive stacking method as an example, related technologies can be referenced in the following patents:

Patent Publication No. CN 112455110 A discloses a process for producing wood flooring using inkjet printing. This patent enables continuing to print additive ink on the surface of the printed pattern texture, thereby forming a convex three-dimensional wood grain on the surface of the pattern texture. However, it has been found from actual testing that due to the certain fluidity of the ink before curing, the forming height is limited, and as the resin flows, the texture angles of the three-dimensional wood grain prepared by this additive stacking method are more rounded compared to natural wood grain, resulting in a very obvious difference between its actual effect and natural wood grain, thus making it difficult to achieve the visual effect and touch sensation of natural solid wood.

Taking the subtractive indentation method as an example, related technologies can be referenced in the following patents:

Patent Publication No. CN 110177691 B discloses a method and apparatus for producing embossing on a substrate using digital printing technology. This method involves applying an embossing liquid on a non-polymerized resin layer, followed by UV curing to perform subsequent polymerization of the resin, and then removing the embossing liquid to form a three-dimensional surface. The three-dimensional wood grain prepared by this method has certain improvements in visual effect and touch sensation compared to the stacking method. However, it has been found from actual testing that after forming the three-dimensional wood grain prepared by this method on the surface of an ink layer having a wood grain pattern, the clarity decreases significantly, specifically manifesting as whitening and large color differences on the surface.

Patent Publication No. CN 112996649 A discloses a method for manufacturing a three-dimensional structure on the surface of a flat substrate, the resulting substrate, and an apparatus for producing the substrate according to this method. It pre-drops a material for forming wood grain grooves on the surface of the substrate, then applies a curable resin to the area of the substrate surface not covered by the material for forming wood grain grooves, and after curing the resin, removes the material for forming wood grain grooves, thereby forming wood grain grooves in the cured resin. However, the depth of its wood grain grooves is always the distance between the upper surface of the cured resin and the substrate surface, that is, the depth of each wood grain groove is consistent. In real wood boards, the depth of surface grooves is variable, so the wood grain grooves formed by this technology differ greatly from the actual situation in terms of depth, resulting in unrealistic issues.

In summary, to measure the similarity degree between the three-dimensional wood grain and natural wood grain, the dimensions that usually need to be considered include: (1) the similarity degree between the width, narrowness, and depth of the three-dimensional wood grain and natural wood grain; (2) the correspondence degree between the three-dimensional wood grain and the underlying two-dimensional planar structure; (3) the color visual effect presented after the three-dimensional wood grain is combined with the underlying two-dimensional plane. Currently, in the forming process of three-dimensional wood grain, the existing disclosed technologies often focus more on the combination of dimension (1) and dimension (2).

Among them: Regarding dimension (1), the width and narrowness as well as depth of the three-dimensional wood grain can be determined by controlling the amount and position of materials during the formation process of the three-dimensional wood grain. For example, the width of the wood grain can be determined by the width of the stacked structure or the breadth in the downward excavation process or the area of embossing liquid spreading. The depth of the three-dimensional wood grain can be determined by the height of upward stacking or the intensity of downward excavation. When the differences in width and depth of the three-dimensional wood grain are more pronounced, the structure presented is more three-dimensional, and the effects it can present in terms of visual and tactile perception are closer to natural wood grain.

Regarding dimension (2), the correspondence degree between the three-dimensional wood grain and the underlying two-dimensional planar structure can be achieved by controlling printing precision, for example, involving control by computer programs and coordinated regulation between the computer and the forming equipment. It also involves various physicochemical properties of the materials themselves, such as their own viscosity, surface energy, and diffusion coefficients between different materials. The higher the correspondence degree between the three-dimensional wood grain and the underlying two-dimensional planar structure, the closer the three-dimensional structure can be to the surface wood grain structure of real solid wood.

Regarding dimension (3), there is currently no more literature or technical disclosure regarding the relationship between three-dimensional structures and visual effects. The few technologies only include effects such as matte or glossy effects of the three-dimensional wood grain, and technologies that truly achieve the visual effect of real wood grain have not yet appeared.

Therefore, in the currently disclosed technologies, no precedent has been seen that simultaneously considers dimension (3) on the premise of achieving dimensions (1) and (2). Therefore, how to simultaneously consider these 3 dimensions is the key point to obtaining a texture similar to natural wood on the surface of engineered boards or non-wood boards.

### SUMMARY OF THE INVENTION

The present invention is to overcome the defect that the method for forming three-dimensional wood grain on the board surface in the prior art cannot obtain a texture similar to natural wood, and provides a method for forming three-dimensional wood grain on the board surface, the resulting board, and applications.

To achieve the above invention objectives, the present invention is implemented through the following technical solutions:

In a first aspect, the present invention first provides a
method for forming a three-dimensional wood grain on the board surface, comprising at least the following steps:
(S.1) A step of causing at least a portion of the board surface to be covered by ink, thereby forming an ink layer having a wood grain pattern;
(S.2) A step of causing at least a portion of the ink layer surface to be covered by resin liquid;
(S.3) A step of curing at least a portion of the resin liquid on the ink layer surface to form a wood grain base layer;
(S.4) A step of causing at least a portion of the wood grain base layer surface to be covered by at least one layer of resin liquid;
(S.5) A step of applying embossing liquid to at least a portion of the surface of the resin liquid on the wood grain base layer surface along the wood grain pattern of the ink layer, thereby causing the embossing liquid and/or at least a portion of the resin liquid mixed with the embossing liquid and/or at least a portion of the resin liquid covered by the embossing liquid to form an embossing layer;
(S.6) A step of curing the resin liquid other than the embossing layer formed in the previous step;
(S.7) A step of removing the embossing layer, thereby forming a three-dimensional wood grain layer on the surface of the wood grain base layer.

Preferably, the amount of resin liquid covered on the wood grain base layer surface in the step (S.4) is greater than or equal to 150 g/m².

Preferably, at least a portion of the wood grain base layer surface in the step (S.4) is covered by at least two layers of resin liquid.

Preferably, in the process of covering at least a portion of the wood grain base layer surface with any two adjacent layers of resin liquid, it further includes a transitional treatment step of stopping the application of force to the resin liquid after the previous layer of resin liquid covering on the wood grain base layer ends, and performing the covering of the next layer of resin liquid after the transitional treatment step ends.

Preferably, in the process of covering at least a portion of the wood grain base layer surface with any two adjacent layers of resin liquid, the force application directions to any two adjacent layers of resin liquid are opposite.

Preferably, the board sequentially completes steps (S.1) to (S.6) during the movement and conveyance in a fixed direction.

Preferably, the embossing liquid in the step (S.5) is applied to the surface of the resin liquid and/or penetrates downward into the interior of the resin liquid.

Preferably, the curing method of the resin liquid covered in the steps (S.2) and (S.4) includes any one of photocuring, thermal curing, or electron beam curing.

Preferably, the resin liquid includes at least a photocrosslinkable resin and a photoinitiator.

Preferably, the photocrosslinkable resin includes any one or a combination of unsaturated polyester, epoxy resin, acrylic resin, acrylic-modified polyurethane resin, acrylic-modified silicone resin, acrylic-modified epoxy resin, water-based epoxy acrylate, water-based polyurethane acrylate, water-based polyester acrylate.

Preferably, the photoinitiator includes any one of free radical polymerization initiator, cationic polymerization initiator, energy transfer type initiator, ionic reaction type initiator.

Preferably, the embossing liquid in the step (S.5) includes at least a polymerization inhibitor for preventing the polymerization of the resin liquid.

In this preferred scheme, adding a polymerization inhibitor to the embossing liquid can quench the free radicals produced by the photoinitiator decomposing under light, thereby effectively preventing the polymerization of the portion of the resin liquid containing the polymerization inhibitor, thereby obtaining an embossing layer that is easy to remove.

Preferably, the resin liquid includes at least a thermosetting resin.

Preferably, the thermosetting resin includes one or a combination of epoxy resin, phenolic resin, melamine formaldehyde resin, furan resin, unsaturated polyester resin, silicone resin, polybutadiene resin.

Preferably, the resin liquid further includes a curing agent.

Preferably, the step (S.4) further includes a step for providing kinetic energy for the embossing liquid to penetrate downward into the interior of the resin liquid.

Preferably, the embossing liquid includes a curable resin.

Preferably, the surface energy of the curable resin included in the embossing liquid after curing is lower than the surface energy of the three-dimensional wood grain layer.

Preferably, the surface energy of the curable resin included in the embossing liquid after curing is lower than 100 mN/m.

Preferably, the curable resin included in the embossing liquid includes any one of fluorocarbon resin, fluorosilicone resin, or silicone resin.

Preferably, the density of the embossing liquid is greater than the density of the resin liquid.

Preferably, the embossing liquid further includes a density modifier for adjusting the density of the embossing liquid.

Preferably, the density modifier is an inorganic solid additive.

Preferably, the density modifier is nano calcium carbonate, nano silicon dioxide, etc.

Preferably, the embossing liquid includes at least two kinds of embossing liquids having different surface tensions.

Preferably, between the board and the wood grain base layer, there are further sequentially provided:
A primer layer for improving the adhesion performance of the board surface;
A color paint layer provided on the surface of the primer layer for covering the substrate color;
An ink layer located on the surface of the color paint layer for forming a wood grain pattern.

Preferably, the outer surface of the three-dimensional wood grain layer is further covered with a topcoat layer, and at least a portion of the topcoat layer is lower than the upper surface of the three-dimensional wood grain layer.

In a third aspect, the present invention further provides a method for preparing the board having the three-dimensional wood grain,
which includes at least the steps of preparing the wood grain base layer and the three-dimensional wood grain layer obtained by the method as described above.

Preferably, it further includes the following steps:
A step of causing at least a portion of the board surface to be covered by primer and curing to obtain a primer layer;
A step of causing at least a portion of the primer layer surface to be covered by color paint and curing to obtain a color paint layer;
A step of causing at least a portion of the color paint layer surface to be covered by ink having a wood grain pattern and curing to obtain an ink layer;
A step of causing at least a portion of the ink layer surface to be covered by the wood grain base layer and the three-dimensional wood grain layer prepared by the method as described above;
A step of causing at least a portion of the three-dimensional wood grain layer surface to be covered by topcoat and curing to obtain a topcoat layer.

Preferably, the coverage amount of the primer is 10-15 g/m²;
the coverage amount of the color paint is 15-20 g/m²;
the coverage amount of the ink is 6-8 g/m²;
the coverage amount of the topcoat is 20-30 g/m².

Preferably, the color paint layer is white.

Preferably, the color paint includes at least photocrosslinkable resin, photoinitiator, and white pigment powder.

In a fourth aspect, the present invention further provides the application of the board having the three-dimensional wood grain in flooring, decorative wall panels or ceiling panels.

Therefore, the present invention has the following beneficial effects:
(1) Through the process described in the present invention, three-dimensional wood grain that is visually and tactilely closer to real wood grain can be prepared on the board surface, to satisfy people's demand for pursuing a more authentic combination of visual sensation and tactile sensation;
(2) Through the preparation process in the present invention, the stability of the board color and pattern can be effectively improved;
(3) The board prepared by the preparation process in the present invention has a higher service life and lower defect rate generation.

### DESCRIPTION OF DRAWINGS

FIG. 1 is a schematic representation diagram of steps (S.1)-(S.7) of the method of the present invention.

FIG. 2 is a schematic representation diagram of steps (S.6)-(S.8) in Example 1 of the present invention.

FIG. 3 is a schematic diagram of the three-dimensional structure of the three-dimensional wood grain prepared in Example 1 of the present invention.

FIG. 4 is a schematic diagram of the top view structure of the three-dimensional wood grain prepared in Example 1 of the present invention.

FIG. 5 is a schematic diagram of the three-dimensional structure of the three-dimensional wood grain prepared in Comparative Example 1 of the present invention.

FIG. 6 is a schematic diagram of the top view structure of the three-dimensional wood grain prepared in Comparative Example 2 of the present invention.

FIG. 7 is a schematic diagram of the three-dimensional structure of the three-dimensional wood grain prepared in Comparative Example 3 of the present invention.

FIG. 8 is a schematic representation diagram of steps (S.6)-(S.8) in Example 2 of the present invention.

FIG. 9 is a schematic representation diagram of the method of coating resin liquid on the wood grain base layer surface in Comparative Example 4 of the present invention.

### DETAILED DESCRIPTION OF THE INVENTION

The present invention is further described below in conjunction with the accompanying drawings of the specification and specific Examples. Those of ordinary skill in the art will be able to implement the present invention based on these descriptions. In addition, the Examples of the present invention involved in the following descriptions are usually only a part of the Examples of the present invention, rather than all Examples. Therefore, based on the Examples in the present invention, all other Examples obtained by those of ordinary skill in the art without creative labor shall belong to the protection scope of the present invention.

As shown in FIG. 1, in the first implementation manner of the present invention, the present invention first provides a method for forming a three-dimensional wood grain on the board surface, comprising at least the following steps:
(S.1) A step of causing at least a portion of the board surface to be covered by ink, thereby forming an ink layer having a wood grain pattern;
(S.2) A step of causing at least a portion of the ink layer surface to be covered by resin liquid;
(S.3) A step of curing at least a portion of the resin liquid on the ink layer surface to form a wood grain base layer;
(S.4) A step of causing at least a portion of the wood grain base layer surface to be covered by at least one layer of resin liquid;
(S.5) A step of applying embossing liquid to at least a portion of the surface of the resin liquid on the wood grain base layer surface along the wood grain pattern of the ink layer, thereby causing the embossing liquid and/or at least a portion of the resin liquid mixed with the embossing liquid and/or at least a portion of the resin liquid covered by the embossing liquid to form an embossing layer;
(S.6) A step of curing the resin liquid other than the sacrificial layer formed in the previous step;
(S.7) A step of removing the embossing layer, thereby forming a three-dimensional wood grain layer on the surface of the wood grain base layer.

In the present invention, the principle applied in the process of forming the three-dimensional wood grain on the board surface is the subtractive indentation method as described in the background art. Compared to the additive stacking method, the texture width formed by it is controllable, the depth is longer, so its three-dimensional sense is stronger. At the same time, no wood grain deformation occurs in the printing process, so the printing precision is higher. However, in the conventional use of the subtractive indentation method to form the three-dimensional wood grain, the process of removing the embossing layer to obtain the three-dimensional wood grain layer will cause exposure of a portion of the ink layer, and this exposed portion of the ink layer is easily worn or even peeled by external forces. Therefore, in the process of mechanically removing the embossing layer, the depth of downward removal needs to be considered to prevent wear of the ink layer, thus making it difficult to increase the depth of the three-dimensional wood grain layer.

The present invention, in the process of preparing the three-dimensional structure, first covers a wood grain base layer obtained by curing resin liquid on the surface of the ink layer, and then forms the three-dimensional wood grain layer again on the surface of the wood grain base layer. Due to the existence of the wood grain base layer, in the process of removing the embossing layer and forming the three-dimensional wood grain layer, the ink layer will not be exposed, but is covered by the wood grain base layer, so the ink layer will not suffer from wear and peeling due to external forces. Therefore, the mechanical removal of the embossing layer can maximize the downward excavation, thereby ensuring that the depth of the three-dimensional wood grain layer can be effectively increased.

In addition, in order to make the board containing the three-dimensional wood grain prepared by the present invention obtain a texture similar to natural wood, in addition to considering the wear of the ink layer and the depth of the three-dimensional wood grain layer, it is also necessary to consider the correspondence between the bottom ink layer and the upper three-dimensional wood grain layer, that is, the alignment issue between the two. Regarding the alignment issue, the applicant has found that the following influencing factors will cause defects of inaccurate alignment between the ink layer and the upper three-dimensional wood grain layer: (1) deformation of the three-dimensional wood grain layer or ink layer caused by the shrinkage of the resin material itself during the curing process in the preparation of the upper three-dimensional wood grain layer; (2) insufficient compatibility between the embossing liquid and the resin liquid in the preparation process of the three-dimensional wood grain layer, leading to the depth, width, and edge morphology of the three-dimensional wood grain layer not matching expectations. The applicant has found that only after considering the above two factors simultaneously can a texture truly similar to natural wood be obtained.

Regarding influencing factor (1), the applicant has found that in the curing process of the resin layer, since the energy used to cure the resin liquid (UV or heat) is usually input from above the resin liquid, the upper resin liquid will cure first, while the lower resin liquid will cure later. Since the resin liquid often accompanies certain volume shrinkage during the curing process, certain internal stresses are generated, and these internal stresses accumulate downward, reaching a maximum at the bottom of the resin liquid. If at this time the resin liquid is in direct contact with the ink layer, once the maximum internal stress is greater than the adhesion between the ink layer and the board surface, it will cause slippage between the ink layer and the board surface, thereby making it difficult for the bottom ink layer and the upper three-dimensional wood grain to correspond, thus causing the alignment inaccuracy problem, which severely affects the visual effect of the board. In addition, in the case where the amount of resin liquid coated above the ink layer is large, peeling and falling off may even occur between the ink layer and the board surface, which severely reduces the product yield.

Therefore, to overcome the above problems, the present invention first covers at least a portion of the ink layer surface with resin liquid and first cures this portion of the resin liquid to form a wood grain base layer. Since the amount of this portion of the resin liquid is small at this time, the internal stress generated after its curing is weak and will not affect between the ink layer and the board surface.

Due to further covering the resin liquid for forming the three-dimensional wood grain layer on the wood grain base layer and curing it to obtain the three-dimensional wood grain layer, the affinity and adhesion between the wood grain base layer and the three-dimensional wood grain layer are strong, so no slippage and peeling problems will occur between the two. Moreover, since the wood grain base layer has high mechanical strength after curing, the internal stress generated during the curing of the three-dimensional wood grain layer is not sufficient to cause deformation of the wood grain base layer, and thus the internal stress generated during the curing of the three-dimensional wood grain layer will not be transmitted to the ink layer located below the wood grain base layer. Therefore, by adding step (S.3), it is possible to prevent to a certain extent the problem of inaccurate alignment between the three-dimensional wood grain layer and the ink layer in the subsequent steps (S.4) to step (S.7).

And regarding influencing factor (2), it is necessary to further improve the compatibility between the embossing liquid and the resin liquid to improve the morphological stability of the embossing layer formed after the embossing liquid enters the resin liquid. Regarding this, the prior art has adopted the step of adding embossing liquid to an incompletely cured resin layer. However, from the actual test effects, due to the high viscosity of the incompletely cured resin layer itself, the embossing liquid is difficult to enter the resin layer. This brings the following problems: (1) the depth of the embossing liquid entering the interior of the resin layer is low, resulting in the depth of the final wood grain also being low, making the overall three-dimensional effect of the three-dimensional wood grain layer poor; (2) due to the high viscosity of the incompletely cured resin layer, the embossing liquid after application is more likely to accumulate on the surface of the incompletely cured resin layer, making the embossing liquid more likely to diffuse on the resin layer surface, making the shape and width of the final formed wood grain difficult to match the underlying ink layer, thus causing the alignment inaccuracy problem; (3) the incompletely cured resin layer has weak fluidity, so it is difficult to co-blend with the embossing liquid in a short time, resulting in the edges of the formed three-dimensional wood grain layer being more blurred and not sharp, thus having obvious differences from the structure of natural wood grain; (4) due to the high viscosity of the incompletely cured resin layer itself, even after mixing with the embossing liquid, the obtained embossing layer has relatively high viscosity. Although the embossing layer cannot be fully cured in the subsequent curing process, its viscosity can still be improved to a certain extent, so in the subsequent mechanical removal process, these high-viscosity embossing layers are difficult to be completely removed, so there is often some residue, further leading to the problem of unclear and blurred wood grain texture, making the gap between its texture and actual natural wood material further widened.

Therefore, the present invention, in addition to adding step (S.3) in the preparation process, also adopts a technical solution of directly applying the embossing liquid to the surface of uncured resin liquid in the preparation process (i.e., step (S.5)). Compared to applying the embossing liquid to the semi-cured resin layer, this change can bring the following beneficial effects: (1) due to the low viscosity of the uncured resin liquid itself, its fluidity is good, and after the embossing liquid is applied to the resin liquid, it can smoothly enter downward into the resin liquid, thereby greatly increasing the depth of the prepared wood grain and effectively improving the three-dimensional effect of the three-dimensional wood grain layer. (2) At the same time, since the embossing liquid can penetrate downward into the interior of the resin liquid, it avoids the diffusion of the embossing liquid on the surface of the uncured resin liquid, thereby making the shape and width of the final formed wood grain able to match the underlying ink layer, thereby effectively improving the alignment accuracy. (3) Due to the good mixing effect between the resin liquid and the embossing liquid, the edges of the embossing liquid or the embossing layer obtained by mixing the embossing liquid with the resin liquid are more neat and sharp, so the prepared three-dimensional wood grain layer is closer to natural wood grain. (4) Due to the embossing liquid or the embossing layer obtained by mixing the embossing liquid with the resin liquid, after curing, its own viscosity is still low, so it is easier to remove after curing, and after removing the embossing layer, it will not produce residue, so the formed wood grain is cleaner and the edges are sharper.

Therefore, in the present invention, by adopting the means of combining step (S.3) and step (S.5), the roles and characteristics of the three-wood grain base layer, resin liquid, and embossing liquid—are interconnected, thereby effectively overcoming the problems in the prior art where the morphological structure of the three-dimensional wood grain layer differs greatly from natural wood grain, and there is inaccurate alignment between the three-dimensional wood grain layer and the underlying ink layer.

In addition, generally speaking, covering other resin layers with transparent effects on the ink layer surface will cause a certain decrease in the clarity of the board surface from a visual perspective, and the degree of clarity decrease will increase with the increase in the thickness or number of resin layers on the ink layer surface. However, the applicant surprisingly found that through the method in the present invention, after adding a wood grain base layer at the bottom of the three-dimensional wood grain layer, the clarity problem is instead improved to a certain extent.

After researching this, the applicant found that after forming the three-dimensional wood grain layer on the ink layer surface, it can form a micro “lens” effect visually, thereby playing a certain magnification role on the underlying pattern. However, when the three-dimensional wood grain layer is directly attached to the ink layer, due to its focal length, it causes certain blurring in the visual effect, resulting in poor clarity. After first providing a wood grain base layer below the three-dimensional wood grain layer in this application, it can play a role in adjusting the focal length of the three-dimensional wood grain layer, thereby effectively improving the clarity of the wood grain.

Therefore, in summary, through the method in this application, a board having a three-dimensional wood grain with stronger three-dimensional sense, more accurate alignment with the ink layer, and texture closer to actual natural wood material can be obtained.

In another preferred implementation manner of the present invention, the amount of resin liquid covered on the wood grain base layer surface in the step (S.2) is 40~50 g/m².

In another preferred implementation manner of the present invention, the amount of resin liquid covered on the wood grain base layer surface in the step (S.4) is greater than or equal to 150 g/m².

The applicant has found through actual exploration that to make the three-dimensional wood grain on the board surface closer to the hand feel of natural wood, it is necessary to control the coating amount of the resin liquid used to form the three-dimensional wood grain. After testing, it has been found that only when the total coating amount of the resin liquid used for the wood grain base layer and the three-dimensional wood grain layer is greater than 200 g/m², the texture formed can achieve a hand feel similar to natural wood, while providing better wear resistance. However, when coating more than 200 g/m² of resin liquid at one time, it will cause difficulty in instantaneous curing at the bottom of the wear-resistant layer, leading to poor bonding force between the three-dimensional wood grain and the ink layer on the board surface, and easy peeling between the three-dimensional wood grain and the substrate.

To achieve smooth curing of a large coating amount of resin liquid and improve the bonding force between the three-dimensional wood grain and the board, it is necessary to increase the curing power used during curing. However, providing high power will generate more waste heat during the curing process, and this generated waste heat will cause deformation of the board and yellowing or aging of the resin liquid, so this means of increasing the curing power is not practical.

After researching the cured three-dimensional wood grain, the applicant has found that the three-dimensional wood grain actually includes two functional zones in the longitudinal direction, including: (1) a bonding zone for bonding with the board, that is, the wood grain base layer in this application; (2) a functional zone for forming a three-dimensional structure, that is, the three-dimensional wood grain layer in this application. The wood grain base layer has low requirements for the amount of resin used, while the amount of the three-dimensional wood grain layer needs to be at least 150 g/m² after calculation by the applicant to achieve a hand feel similar to natural wood and better wear resistance.

Therefore, this application coats a first layer of resin liquid on the board surface, and after curing it, obtains the wood grain base layer. Since the amount of resin liquid used to form the wood grain base layer is small, it can be fully cured under conventional curing power, making the bonding force between the wood grain base layer and the board effectively improved, and no peeling problem will occur during use. Subsequently, the resin coating amount of the overall three-dimensional wood grain on the surface of the wood grain base layer is increased to 150 g/m² or more, thereby ensuring the three-dimensional sense of the three-dimensional wood grain.

In another preferred implementation manner of the present invention, at least a portion of the wood grain base layer surface in the step (S.4) is covered by at least two layers of resin liquid.

In another preferred implementation manner of the present invention, in the process of covering at least a portion of the wood grain base layer surface with any two adjacent layers of resin liquid, it further includes a transitional treatment step of stopping the application of force to the resin liquid after the previous layer of resin liquid covering on the wood grain base layer ends, and performing the covering of the next layer of resin liquid after the transitional treatment step ends.

As described above, in this application, to ensure the three-dimensional sense of the three-dimensional wood grain, at least 150 g/m² or more of resin liquid needs to be coated on the wood grain base layer surface. Therefore, the focus of this application shifts to how to form a three-dimensional wood grain layer with a resin coating amount of 150 g/m² or more on the surface of the wood grain base layer.

Currently, the most common way to apply resin liquid is to use a roller coating machine for coating. The applicant once attempted to coat an amount as high as 150 g/m² or more of resin liquid on the wood grain base layer at one time, but the applicant found that this one-time coating method requires loading too much resin liquid on a single roller. If a conventional roller is used, loading too thick resin liquid will cause the resin liquid to flow downward, making normal production impossible.

Therefore, to solve the above problems, the present invention adopts a two-roller distributed coating means, so that each roller coats one layer of resin liquid, thereby making the total resin amount of the two layers of resin liquid greater than 150 g/m² or more. This practice achieves large resin amount coating while reducing the resin load pressure on each roller.

In the prior art, to achieve multi-roller coating, a roller coating machine with two parallel rollers is usually used. The two rollers of the roller coating machine usually adopt a combination of one forward roller and one reverse roller. In the process of the first roller coating the resin liquid on the board surface and pushing the substrate forward, it will generate a certain force on the board and the uncured resin liquid layer attached to the board surface along the board conveyance direction. This force combined with the bristle structure on the roller surface will cause certain deformation on the resin liquid surface. And before the first layer of resin liquid has leveled, the second roller has already taken over the board coated with uncured resin liquid, and it will generate a force opposite to the board conveyance direction on the uncured resin liquid, so this force will also cause deformation of the coated second layer of resin liquid in the opposite direction. At the same time, due to the certain speed difference between the second roller and the first roller, the deformation between the first layer of resin liquid and the second layer of resin liquid cannot be offset, but instead the deformations of the two layers of resin liquid accumulate with each other, further exacerbating the appearance of marks on the resin liquid, and after curing, these marks will be fixed, severely affecting the visual effect of the final product. The generation of such marks will cause more obvious defects in the appearance of the finished product, especially the finished product with relatively shallow textures, that is, from a distance, it can be seen that there is a stutter in the middle of the portion coated with resin liquid.

Therefore, on the basis of the existing roller coating machine, this application adds a transitional treatment step of stopping the application of force to the resin liquid in the process of covering at least a portion of the wood grain base layer surface with any two adjacent layers of resin liquid. In this manner, in the process of the board passing through the first roller, after the overall force application of the first roller to the board ends, before being conveyed to the second roller, no force will be applied to the entire board anymore, and then after experiencing a longer distance, it is beneficial to the leveling of the first layer of resin liquid. At this time, the board is coated by the second roller from beginning to end. At this time, due to the small deformation amount of the second layer of resin liquid, it can quickly level before curing, thereby eliminating the influence of the force and speed difference of the two rollers on the surface morphology.

In another preferred implementation manner of the present invention, in the process of covering at least a portion of the wood grain base layer surface with any two adjacent layers of resin liquid, the force application directions to any two adjacent layers of resin liquid are opposite.

From the above discussion, it can be seen that the roller coating machine will generate a certain force on the resin liquid during roller coating. Since the resin liquid usually contains high molecular polymers or prepolymers with long molecular chain segments, it will produce certain elastic deformation and orientation force under external force. Due to the short overall process time from coating to curing of the resin liquid, the molecular chain segments of the high molecular polymers in the resin liquid often solidify before returning to the initial state, leading to large internal stress in the middle of the cured three-dimensional wood grain layer, thereby causing the middle of the cured three-dimensional wood grain layer to be prone to cracking. Therefore, to reduce the generation of internal stress in the middle of the three-dimensional wood grain layer, this application specifically adjusts the force application directions of the two rollers to the any two adjacent layers of resin liquid to be opposite in the process of covering at least a portion of the wood grain base layer surface with any two adjacent layers of resin liquid, so that during the working process of the second roller, it can provide a force opposite to its internal stress to the uncured second wear-resistant layer, thereby weakening or offsetting the original internal stress in the three-dimensional wood grain layer, thereby reducing the probability of cracking phenomenon in the middle of the cured three-dimensional wood grain layer.

In another preferred implementation manner of the present invention, the board sequentially completes steps (S.1) to (S.6) during the movement and conveyance in a fixed direction.

In another preferred implementation manner of the present invention, the embossing liquid in the step (S.5) is applied to the surface of the resin liquid and/or penetrates downward into the interior of the resin liquid.

In this application, the principle of forming the embossing layer by adding embossing liquid to the resin liquid surface has multiple types, including but not limited to UV blocking method, free radical absorption method, or volume occupation method.

Among them: the UV blocking method is applicable to UV-cured resin liquid, and its principle lies in covering a layer of embossing liquid capable of preventing ultraviolet penetration on the surface of the uncured resin liquid, thereby making the resin liquid located below the embossing liquid maintain a liquid uncured state, so this portion of uncured resin liquid forms the embossing layer, thereby removing it through mechanical cleaning or solution washing in the subsequent processing process, thereby obtaining a three-dimensional wood grain layer with imitation wood grain structure.

While the free radical absorption method is applicable to resin liquid based on free radical polymerization principle, its principle lies in applying to the surface of the uncured resin liquid or penetrating downward into the interior of the uncured resin liquid, thereby being able to absorb the free radicals used for polymerizing the resin liquid to undergo free radical polymerization and curing, thereby making the portion of the resin liquid containing the embossing liquid maintain a liquid uncured state, so this portion of uncured resin liquid forms the embossing layer, thereby removing it through mechanical cleaning or solution washing in the subsequent processing process, thereby obtaining a three-dimensional wood grain layer with imitation wood grain structure.

While the volume occupation method refers to when the embossing liquid penetrates downward into the interior of the uncured resin liquid, it squeezes away the uncured resin liquid, so the portion of the volume occupied only contains the embossing liquid, and the embossing liquid can be polymerizable or non-polymerizable. Finally, through the principle of mechanical or solvent cleaning, the embossing liquid is cleaned and removed, thereby obtaining a three-dimensional wood grain layer with imitation wood grain structure.

In another preferred implementation manner of the present invention, the curing method of the resin liquid covered in the steps (S.2) and (S.4) includes any one of photocuring, thermal curing, or electron beam curing.

In another preferred implementation manner of the present invention, the resin liquid includes at least a photocrosslinkable resin and a photoinitiator.

In another preferred implementation manner of the present invention, the photocrosslinkable resin includes any one or a combination of unsaturated polyester, epoxy resin, acrylic resin, acrylic-modified polyurethane resin, acrylic-modified silicone resin, acrylic-modified epoxy resin, water-based epoxy acrylate, water-based polyurethane acrylate, water-based polyester acrylate.

In another preferred implementation manner of the present invention, the photoinitiator includes any one of free radical polymerization initiator, cationic polymerization initiator, energy transfer type initiator, ionic reaction type initiator.

In another preferred implementation manner of the present invention, the embossing liquid in the step (S.5) includes at least a polymerization inhibitor for preventing the polymerization of the resin liquid.

In this preferred scheme, adding a polymerization inhibitor to the embossing liquid can quench the free radicals produced by the photoinitiator decomposing under light, thereby effectively preventing the polymerization of the portion of the resin liquid containing the polymerization inhibitor or reducing the curing speed of the portion of the resin liquid containing the polymerization inhibitor, making the portion of the resin liquid containing the polymerization inhibitor still able to maintain a liquid or semi-solid state after the end of step (S.6), thereby making the embossing layer easier to remove.

In another preferred implementation manner of the present invention, the resin liquid includes at least a thermosetting resin.

In another preferred implementation manner of the present invention, the thermosetting resin includes one or a combination of epoxy resin, phenolic resin, melamine formaldehyde resin, furan resin, unsaturated polyester resin, silicone resin, polybutadiene resin.

In another preferred implementation manner of the present invention, the resin liquid further includes a curing agent.

In another preferred implementation manner of the present invention, the step (S.4) further includes a step for providing kinetic energy for the embossing liquid to penetrate downward into the interior of the resin liquid.

After the embossing liquid is applied to the surface of the uncured resin liquid, it may not be able to quickly penetrate into the interior of the uncured resin liquid, thereby causing the problem of insufficient depth of the three-dimensional wood grain in some Examples. Therefore, to make the three-dimensional wood grain have a stronger three-dimensional sense, the applicant proposes to solve this technical problem from the aspect of improving the downward penetration speed of the embossing liquid. The applicant has found that after providing kinetic energy to the embossing liquid, it can enter the interior of the uncured resin liquid at a faster speed or kinetic energy, thereby increasing the depth of the three-dimensional wood grain.

In another preferred implementation manner of the present invention, the embossing liquid includes a curable resin.

The curable resin included in the embossing liquid includes acrylic resin, epoxy resin, or other curable resins.

In another preferred implementation manner of the present invention, the surface energy of the curable resin included in the embossing liquid after curing is lower than the surface energy of the three-dimensional wood grain layer.

In some preferred schemes of this application, the embossing liquid includes a resin with surface energy lower than that of the three-dimensional wood grain layer, making its adhesion to the three-dimensional wood grain layer after curing weaker, thereby making the embossing liquid after curing able to be easily removed through mechanical or solvent cleaning steps.

In another preferred implementation manner of the present invention, the surface energy of the curable resin included in the embossing liquid after curing is lower than 100 mN/m.

In another preferred implementation manner of the present invention, the curable resin included in the embossing liquid includes any one of fluorocarbon resin, fluorosilicone resin, or silicone resin.

In another preferred implementation manner of the present invention, the density of the embossing liquid is greater than the density of the resin liquid.

In addition to actively providing kinetic energy to the embossing liquid as described above, the applicant also proposes that in some preferred schemes of this application, the speed of the embossing liquid penetrating downward into the interior of the uncured resin liquid can be further improved by passively increasing the kinetic energy of the embossing liquid. For example, by regulating the density of the embossing liquid to make the density of the embossing liquid greater than the density of the resin liquid, after applying an equal volume of embossing liquid to at least a portion of the surface of the uncured resin liquid, the mass of the embossing liquid is higher, so its kinetic energy is greater when entering the interior of the uncured resin liquid, thereby making the depth of the formed three-dimensional wood grain layer deeper. At the same time, after the high-density embossing liquid enters the resin liquid, due to its own gravity, it is also easier to quickly enter downward into the uncured resin liquid.

In another preferred implementation manner of the present invention, the embossing liquid further includes a density modifier for adjusting the density of the embossing liquid.

In another preferred implementation manner of the present invention, the density modifier is an inorganic solid powder additive.

In another preferred implementation manner of the present invention, the density modifier can be an inorganic solid additive, such as calcium carbonate, silicon dioxide, etc.

In another preferred implementation manner of the present invention, the embossing liquid includes at least two kinds of embossing liquids having different surface tensions.

As described in the background art, to make the three-dimensional structure achieve a hand feel similar to actual wood, in addition to the depth mentioned above, another key point lies in how to control the width of the three-dimensional structure. Regarding the width of the three-dimensional structure currently, its width control is mainly based on the amount of sprayed embossing liquid. Usually, the larger the amount of sprayed embossing liquid or the larger the individual droplet of the embossing liquid, the larger the width of the wood grain groove, while the smaller the amount of sprayed embossing liquid or the smaller the droplet of the embossing liquid, the smaller the width of the formed wood grain groove.

However, the above scheme has the following two problems:
(1) To form a wider three-dimensional wood grain, more embossing liquid needs to be added. Since the embossing liquid needs to be removed in the final step, adding more embossing liquid will cause more waste of embossing liquid.
(2) To form a narrower three-dimensional wood grain, less amount of embossing liquid needs to be added, but doing so will cause the depth of the three-dimensional wood grain to be too small, and there may also be insufficient precision of the three-dimensional wood grain, causing unnatural defects in the three-dimensional wood grain.

To address the above problems, this application proposes a solution, that is, selecting materials with different tensions for the embossing liquid used to form a wider three-dimensional wood grain and the embossing liquid used to form a narrower three-dimensional wood grain.

In the case of using embossing liquid with smaller tension, it is easier to spread on the wear-resistant layer surface. In this case, the contact angle between the small tension embossing liquid and the wear-resistant layer is smaller. Because in the same volume situation, the area it can spread is larger, equivalent to being able to achieve a wider three-dimensional wood grain with less embossing liquid.

While in the case of using embossing liquid with larger tension, it is not easy to spread on the wear-resistant layer surface. In this case, the contact angle between the large tension embossing liquid and the wear-resistant layer is larger, so in the same volume situation, the height of its droplet is higher. Therefore, under the condition of using a smaller amount of larger tension embossing liquid, it can obtain a finer and deeper three-dimensional wood grain.

In another preferred implementation manner of the present invention, the coverage amount of ink covered on the board surface in the step (S.1) is 6-8 g/m².

In another preferred implementation manner of the present invention, the amount of resin liquid covered on the wood grain base layer surface in the step (S.2) is 30~50 g/m².

In a second aspect, in another preferred implementation manner of the present invention, the present invention further provides a board having a three-dimensional wood grain, comprising a board;
the surface of the board includes the wood grain base layer and the three-dimensional wood grain layer prepared by the method as described above.

In another preferred implementation manner of the present invention, between the board and the wood grain base layer, there are further sequentially provided:
A primer layer for improving the adhesion performance of the board surface;
A color paint layer provided on the surface of the primer layer for covering the substrate color;
An ink layer located on the surface of the color paint layer for forming a wood grain pattern.

In another preferred implementation manner of the present invention, the outer surface of the three-dimensional wood grain layer is further covered with a topcoat layer, and at least a portion of the topcoat layer is lower than the upper surface of the three-dimensional wood grain layer.

In a third aspect, in another preferred implementation manner of the present invention, the present invention further provides a method for preparing the board having the three-dimensional wood grain,
which includes at least the steps of preparing the wood grain base layer and the three-dimensional wood grain layer obtained by the method as described above.

In another preferred implementation manner of the present invention, it further includes the following steps:
A step of causing at least a portion of the board surface to be covered by primer and curing to obtain a primer layer;
A step of causing at least a portion of the primer layer surface to be covered by color paint and curing to obtain a color paint layer;
A step of causing at least a portion of the color paint layer surface to be covered by ink having a wood grain pattern and curing to obtain an ink layer;
A step of causing at least a portion of the ink layer surface to be covered by the wood grain base layer and the three-dimensional wood grain layer prepared by the method as described above;
A step of causing at least a portion of the three-dimensional wood grain layer surface to be covered by topcoat and curing to obtain a topcoat layer.

In another preferred implementation manner of the present invention, the coverage amount of the primer is 10-15 g/m²;
the coverage amount of the color paint is 15-20 g/m²;
the coverage amount of the topcoat is 20-30 g/m².

In another preferred implementation manner of the present invention, the color paint layer is white.

In another preferred implementation manner of the present invention, the color paint includes at least photocrosslinkable resin, photoinitiator, and white pigment powder.

In a fourth aspect, the present invention further provides the application of the board having the three-dimensional wood grain in flooring, decorative wall panels or ceiling panels.

The following Examples are provided only to illustrate the present invention and are not intended to limit the protection scope defined by the appended claims.

### Example 1

The method for forming a three-dimensional wood grain on the board surface includes the following steps:
(S.1) Placing an SPC board with length, width, and thickness of 1260 mm*970 mm*4.85 mm on the surface of a conveying device moving in a fixed direction;
(S.2) The SPC board first passes through a first roller coating machine during the conveying process. The coating roller surface of the roller coating machine is attached with a photocurable primer (the primer includes: 90% photocurable clear varnish HYS01-1, 5% photoinitiator 184, 0.5% photoinitiator TPO, 4.5% diluent hydroxyethyl acrylate). During the contact process between the SPC board and the coating roller, 12 g/m² of primer is coated on the surface of the SPC board, and cured with a 395 nm and 8 W/cm² UV lamp, making the primer form a primer layer;
(S.3) The SPC board obtained in the previous step passes through a second roller coating machine again. The coating roller surface of the roller coating machine is attached with a photocurable white paint (the white paint includes: 50% photocurable epoxy HYS01-1, 30% titanium dioxide, 5% photoinitiator 184, 0.5% photoinitiator TPO, 14.5% diluent hydroxyethyl acrylate). During the contact process between the SPC board and the coating roller, 18 g/m² of white paint is coated on the surface of the primer, and after curing with a 395 nm and 8 W/cm² UV lamp, a white color paint layer is obtained;
(S.4) The SPC board obtained in the previous step is conveyed to the first inkjet printing machine, so that the surface of the color paint layer is sprayed with 6-8 g/m² of ink through the first inkjet printing machine. After curing the ink, an ink layer having a wood grain pattern is formed on the surface of the primer layer;
(S.5) The SPC board obtained in the previous step is conveyed to the third roller coating machine, and 45 g/m² of photocurable resin liquid (the resin liquid includes: 90% Dow Corning 65 Additive, 5% photoinitiator 184, 0.5% photoinitiator TPO, 4.5% diluent hydroxyethyl acrylate) is roller coated on the ink layer surface, and after sequentially passing through irradiation and curing of a 395 nm and 8 W/cm² UV lamp and a 160 w/cm² Hg lamp, the wood grain base layer is formed;
(S.6) The SPC board obtained in the previous step is conveyed to the fourth roller coating machine, so that the coating roller of the fourth roller coating machine roller coats 80 g/m² of resin liquid (the resin liquid includes: 90% Dow Corning 65 Additive, 5% photoinitiator 184, 0.5% photoinitiator TPO, 4.5% diluent hydroxyethyl acrylate) along the conveyance direction of the SPC board (the rotation direction of the roller itself is clockwise) on the wood grain base layer surface;
(S.7) After coating the first layer of resin liquid, the SPC board is conveyed forward along the surface of the conveying device, and it is ensured that before being conveyed to the next roller coating machine, the fourth roller coating machine does not apply any force to the resin liquid;
(S.8) The SPC board obtained in the previous step is conveyed to the fifth roller coating machine, so that the coating roller of the fifth roller coating machine continues to roller coat 75 g/m² of resin liquid against the conveyance direction of the SPC board (the rotation direction of the roller itself is clockwise);

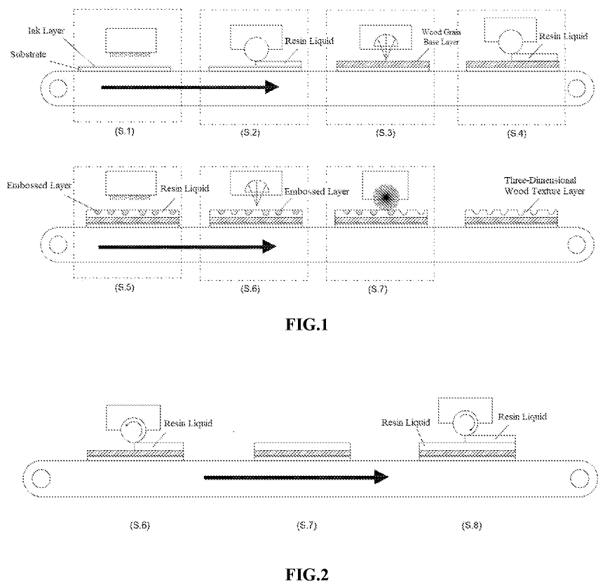

FIG. 2 shows a schematic diagram of steps (S.6) to step (S.8) in this Example, thereby better understanding these three steps;
(S.9) The SPC board obtained in the previous step is conveyed to the second inkjet printing machine, so that 6-8 g/m² of embossing liquid (the embossing liquid includes: 45.5% diacrylate monomer PEG600DA, 20.5% p-hydroxyanisole HQMME, 10% 2-tert-butylhydroquinone MTBHQ, 24% diethylene glycol butyl ether) is sprayed on the surface of the resin liquid, and the embossing liquid penetrates downward into the resin liquid and mixes with the resin liquid to form an embossing layer;
(S.10) The portion of the resin liquid on the surface of the SPC board obtained in the previous step other than the embossing layer is sequentially irradiated through a 395 nm and 8 W/cm² UV lamp and a 160 w/cm² Hg lamp to achieve deep curing;
(S.11) The SPC board obtained in the previous step is conveyed below a cleaning device containing a steel brush, so that the embossing layer is brushed out by the steel brush, thereby forming a three-dimensional wood grain layer;
(S.12) The SPC board obtained in the previous step passes through the sixth roller coating machine and a 395 nm and 8 W/cm² UV ultraviolet lamp, thereby coating 12 g/m² of first topcoat on the surface of the three-dimensional wood grain layer, and curing it to obtain a first topcoat layer;
(S.13) The SPC board obtained in the previous step passes through the seventh roller coating machine and a 395 nm and 8 W/cm² UV ultraviolet lamp, thereby coating 12 g/m² of second topcoat on the surface of the first topcoat layer, and curing it to obtain a second topcoat layer.

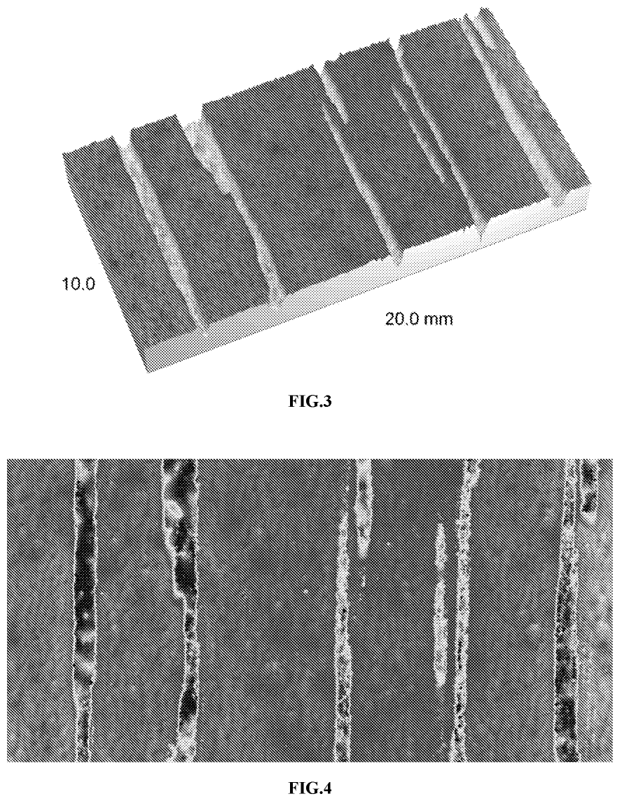

The board with a three-dimensional structure surface prepared in Example 1 was analyzed using a laser profilometer, obtaining FIG. 3 and FIG. 4, where: FIG. 3 is a schematic diagram of the three-dimensional structure of the three-dimensional wood grain, and FIG. 4 is a schematic diagram of the top view structure of the three-dimensional wood grain.

### Comparative Example 1

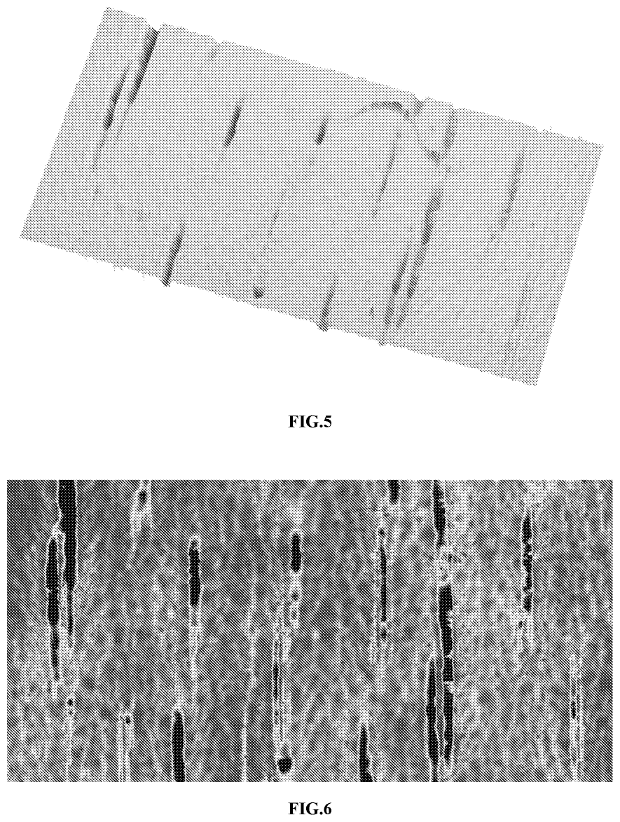

Comparative Example 1 is basically the same as the steps of Example 1, the difference lies in that step (S.5) is omitted in Comparative Example 1, so the prepared three-dimensional structure does not include the wood grain base layer. FIG. 5 and FIG. 6 are respectively the schematic diagram of the three-dimensional structure of the three-dimensional wood grain prepared in Comparative Example 1 of the present invention and the schematic diagram of the top view structure of the three-dimensional wood grain. From the figures, it can be seen that after omitting step (S.5), the average depth of the formed wood grain is lower.

### Comparative Example 2

Comparative Example 2 is basically the same as the steps of Example 1, the difference lies in that in step (S.5), the resin liquid is incompletely cured until gelation.

### Comparative Example 3

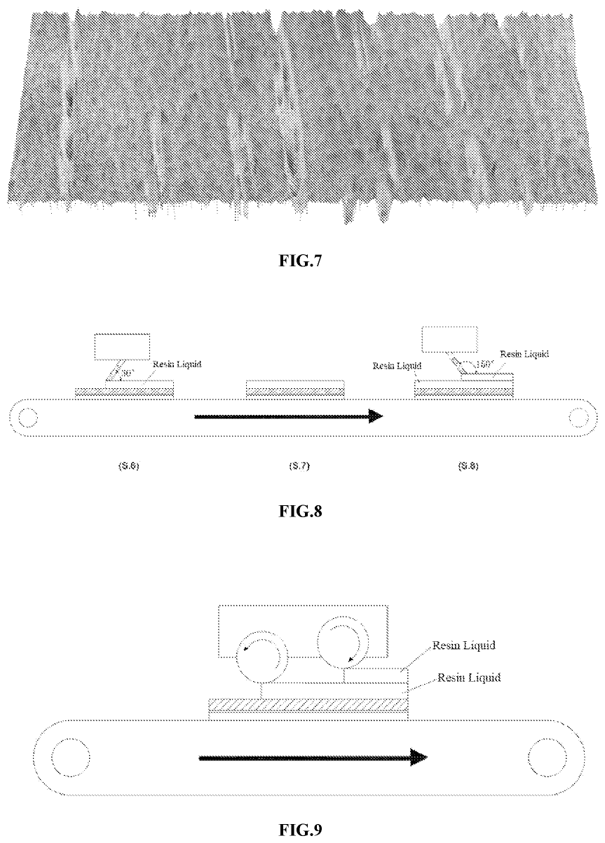

Comparative Example 3 is basically the same as the steps of Example 1, the difference lies in that after step (S.8), ultraviolet light is applied to the resin liquid, thereby obtaining an incompletely cured gel-like resin layer. FIG. 7 is a schematic diagram of the three-dimensional structure of the three-dimensional wood grain prepared in Comparative Example 3 of the present invention. From the figure, it can be seen that the depth of the three-dimensional wood grain obtained differently in Comparative Example 3 is lower, and its edges are more unclear.

### Product Testing:

Surface abrasion resistance test: Tested according to standard GT/T 18102-2020.
Surface scratch resistance index test: Tested according to standard GT/T 18102-2020.
Clarity test: Tested according to standard JIS K7374.

Product qualification rate test: According to the methods in the above Example 1, Comparative Example 1, and Comparative Example 2, 50 boards were batch produced respectively, observing whether the boards have cracking or delamination phenomena, and measuring the initial warpage degree and heated warpage degree of the boards, and statistically the product qualification rate. The results are shown in Table 1. Among them, the boards with visually observable quality problems and heated warpage degree greater than 1 mm/m are recorded as unqualified.

Alignment accuracy test: Visually observe the alignment accuracy, observing whether there is offset, ghosting, or damage.

Warpage test: Cut the board into 240 mm*240 mm samples, place the wear-resistant layer upward on the aluminum plate, place at 23±2° C. and 50±5% RH conditions for 24 h, measure the average initial warpage degree of the board through caliper; Adjust the temperature in the constant temperature drying oven to 80° C., place the sample together with the aluminum plate into the constant temperature drying oven for 6 h, then take out the sample together with the aluminum plate, place at 23±2° C. and 50±5% RH conditions for 24 h, measure the average heated warpage degree of the board through caliper.

The board performance test results of Example 1 and Comparative Examples 1 to 3 are shown in Table 1 below:

TABLE 1
Performance Test Results

| | | | Comparative | Comparative | Comparative |
|---|---|---|---|---|---|
| Item | | Example 1 | Example 1 | Example 2 | Example 3 |
| Surface Abrasion | | ≥6000 cycles | ≥4500 cycles | ≥6000 cycles | ≥6000 cycles |
| Resistance | | | | | |
| Surface Scratch | | ≥4.0N | 2-3N | ≥4.0N | ≥4.0N |
| Resistance Index | | | | | |
| Clarity | | 83.6% | 59.3% | 78.5% | 71.5% |
| Alignment | | Accurate | Slight | Slight | Obvious |
| Accuracy | | alignment | offset | offset | offset |
| Qualification Rate | | 100% | 86% | 94% | 76% |
| Warpage | Average | 0.25 | 0.42 | 0.34 | 0.26 |
| Test | Initial | | | | |
| | Warpage | | | | |
| | (mm/m) | | | | |
| | Average | 0.43 | 0.88 | 0.56 | 0.45 |
| | Heated | | | | |
| | Warpage | | | | |
| | (mm/m) | | | | |

### Example 2

Example 2 is basically the same as the steps of Example 1, the difference lies in changing the covering method of the resin liquid in steps (S.6) to step (S.8). As shown in FIG. 8, in this Example, a spray method is used in steps (S.6) and (S.8) to sequentially spray the resin liquid onto the surface of the wood grain base layer. During the spraying process, a certain angle is formed between the nozzle and the SPC board.

Among them: In step (S.6), the nozzle forms a certain angle against the conveyance direction of the SPC board (in this Example, an acute angle of 30° is formed between the nozzle and the conveyance direction of the SPC board.) While in step (S.8), the nozzle forms a certain angle along the conveyance direction of the SPC board (in this Example, an obtuse angle of 150° is formed between the nozzle and the conveyance direction of the SPC board).

### Example 3

Example 3 is basically the same as the steps of Example 1, the difference lies in changing the composition and curing method of the resin liquid in steps (S.5) to step (S.8).

The composition of the resin liquid can choose to use a thermosetting resin system, specifically as follows:

| | |
|---|---|
| Resin (bisphenol A type epoxy resin E-51) | 100 parts; |
| Curing agent (methyltetrahydrophthalic anhydride) | 30 parts; |
| Reactive diluent (butyl glycidyl ether BGE) | 15 parts; |
| Accelerator (DMP30) | 10 parts. |

After coating the thermosetting resin system obtained by mixing the above formulation onto the SPC board surface, the ambient temperature where the SPC board is located is raised to 140° C. through infrared heating, making the above thermosetting resin system cured.

The board performance test results of Example 3 are shown in Table 2 below:

TABLE 2
Performance Test Results

| | |
|---|---|
| Item | Example 3 |

| Surface Abrasion | | ≥6000 cycles |
|---|---|---|
| Resistance | | |
| Surface Scratch | | ≥4.0N |
| Resistance Index | | |
| Clarity | | 85.9% |
| Alignment Accuracy | | Accurate alignment |
| Qualification Rate | | 96% |
| Warpage | Average Initial | 0.61 |
| Test | Warpage (mm/m) | |
| | Average Heated | 0.65 |
| | Warpage (mm/m) | |

### Example 4

Example 4 is basically the same as the steps of Example 1, the difference lies in changing the composition of the embossing liquid in step (S.9).

In this Example, the embossing liquid is a polytetrafluoroethylene emulsion with a solid content of 60%. After coating the polytetrafluoroethylene emulsion onto the resin liquid, it penetrates downward into the interior of the resin liquid. Since the polytetrafluoroethylene emulsion is water-based, it will not mix with the resin liquid after penetrating into the resin liquid, so after the resin liquid is cured, a portion of the water in the polytetrafluoroethylene emulsion evaporates due to heat, thereby forming a polytetrafluoroethylene layer. Since the surface energy of the polytetrafluoroethylene layer is lower than 100 mN/m, it will not adhere to the cured resin liquid, thereby being easier to remove.

### Example 5

Example 5 is basically the same as the steps of Example 4, the difference lies in: when applying the embossing liquid (polytetrafluoroethylene emulsion with a solid content of 60%) to the resin liquid, the speed of injecting the embossing liquid into the resin liquid is increased to 5 m/s.

The specific effects are shown in Table 3 below:

TABLE 3
Performance Test Results

| Item | Example 4 | Example 5 |
|---|---|---|
| Embossing Liquid | 3 m/s | 5 m/s |
| Injection Speed | | |
| Maximum Groove Depth | 69 μm | 81 μm |

From Table 1 above, it can be seen that after increasing the injection speed of the embossing liquid, the depth of the three-dimensional structure finally formed on the board surface is significantly increased, with a maximum depth increase of 17.4%.

### Example 6

Example 6 is basically the same as the steps of Example 4, the difference lies in: nano silicon dioxide is added to the embossing liquid (polytetrafluoroethylene emulsion with a solid content of 60%), making the density of the embossing liquid increased from 1.5 g/cm³ to 2.0 g/cm³.

The specific effects are shown in Table 4 below:

TABLE 4
Performance Test Results

| Item | Example 4 | Example 6 |
|---|---|---|
| Embossing Liquid Density | 1.5 g/cm³ | 2.0 g/cm³ |
| Maximum Groove Depth | 69 μm | 88 μm |

From Table 3 above, it can be seen that after increasing the density of the embossing liquid, the depth of the three-dimensional structure finally formed on the board surface is significantly increased, with a maximum depth increase of 27.5%.

### Comparative Example 4

Comparative Example 4 is basically the same as the steps of Example 1, the difference lies in combining steps (6) to step (8) using a traditional dual-roller roller coating machine for coating.

Its structural schematic diagram during the roller coating process is as shown in FIG. 8. When the SPC board covered with the wood grain base layer is conveyed to below the dual-roller roller coating machine along the conveying mechanism, the board first coats a layer of resin liquid to form resin liquid 1 on the surface of the wood grain base layer when passing through the first roller of the dual-roller roller coating machine. Subsequently, before the wood grain base layer surface is completely covered by resin liquid 1, the SPC board immediately passes through the second roller of the dual-roller roller coating machine again, thereby continuing to coat a layer of resin liquid on the surface of resin liquid 1 to form resin liquid 2, until resin liquid 1 and resin liquid 2 completely cover the surface of the wood grain base layer.

FIG. 2 is an image of the board with a three-dimensional structure surface prepared by the method in Comparative Example 4. From the figure, it can be seen that the board prepared by the method in Comparative Example 4 has obvious marks on the surface.

The board performance test results of Comparative Example 4 are shown in Table 5 below:

TABLE 5
Performance Test Results

| | |
|---|---|
| Item | Comparative Example 4 |

| Surface Abrasion | | ≥6000 cycles |
|---|---|---|
| Resistance | | |
| Surface Scratch | | ≥4.0N |
| Resistance Index | | |
| Clarity | | 78.3% |
| Alignment Accuracy | | Accurate alignment |
| Qualification Rate | | 62% |
| Warpage | Average Initial | 0.25 |
| Test | Warpage (mm/m) | |
| | Average Heated | 0.43 |
| | Warpage (mm/m) | |

What is claimed is:

1. A method for forming a three-dimensional wood grain on a surface of a board, characterized in that it comprises at least the following steps:
(S.1) covering at least a portion of the board surface with ink to form an ink layer having a wood grain pattern;
(S.2) covering at least a portion of the ink layer surface with a resin liquid;
(S.3) curing at least a portion of the resin liquid on the ink layer surface to form a wood grain base layer;
(S.4) covering at least a portion of the wood grain base layer surface with at least one layer of resin liquid;
(S.5) applying an embossing liquid to at least a portion of the resin liquid surface on the wood grain base layer along the wood grain pattern of the ink layer, such that the embossing liquid, and/or at least a portion of the resin liquid mixed with the embossing liquid, and/or at least a portion of the resin liquid covered by the embossing liquid forms an embossing layer;
(S.6) curing the resin liquid excluding the embossing layer formed in the previous step;
(S.7) removing the embossing layer to form a three-dimensional wood grain layer on the surface of the wood grain base layer.

2. The method according to claim 1, characterized in that the amount of resin liquid applied to the surface of the wood grain base layer in step (S.4) is greater than or equal to 150 g/m².

3. The method according to claim 2, characterized in that at least a portion of the wood grain base layer surface in step (S.4) is covered with at least two layers of resin liquid.

4-5. (canceled)

6. The method according to claim 1, characterized in that the board sequentially undergoes steps (S.1) to (S.6) during transport in a fixed direction.

7. The method according to claim 1, characterized in that, in step (S.5), the embossing liquid is applied to the surface of the resin liquid and/or penetrates downward into the interior of the resin liquid.

8. The method according to claim 1, characterized in that the curing method for the resin liquid applied in steps (S.2) and (S.4) comprises any one of photocuring, thermal curing, or electron beam curing.

9. The method according to claim 8, characterized in that the resin liquid comprises at least a photocrosslinkable resin and a photoinitiator.

10. The method according to claim 9, characterized in that the embossing liquid in step (S.5) comprises at least a polymerization inhibitor for preventing polymerization of the photocrosslinkable resin.

11. The method according to claim 9, characterized in that the photocrosslinkable resin comprises one or a combination of unsaturated polyester, epoxy resin, acrylic resin, acrylic-modified polyurethane resin, acrylic-modified silicone resin, acrylic-modified epoxy resin, water-based epoxy acrylate, water-based polyurethane acrylate, or water-based polyester acrylate.

12. The method according to claim 9, characterized in that the photoinitiator comprises any one of a free radical polymerization initiator, a cationic polymerization initiator, an energy transfer initiator, or an ionic reaction initiator.

13. The method according to claim 8, characterized in that the resin liquid comprises at least a thermosetting resin.

14. The method according to claim 13, characterized in that the thermosetting resin comprises one or a combination of epoxy resin, phenolic resin, melamine formaldehyde resin, furan resin, unsaturated polyester resin, silicone resin, or polybutadiene resin.

15. The method according to claim 13, characterized in that the resin liquid further comprises a curing agent for catalyzing the curing of the thermosetting resin.

16. The method according to claim 7, characterized in that step (S.4) further comprises a step of providing kinetic energy to facilitate the downward penetration of the embossing liquid into the interior of the resin liquid.

17. The method according to claim 16, characterized in that the embossing liquid comprises a curable resin.

18-20. (canceled)

21. The method according to any one of claim 1, characterized in that the density of the embossing liquid is greater than the density of the resin liquid.

22. The method according to claim 21, characterized in that the embossing liquid further comprises a density modifier for adjusting the density of the embossing liquid.

23. (canceled)

24. The method according to any one of claim 1, characterized in that the embossing liquid comprises at least two types of embossing liquids having different surface tensions.

25. The method according to claim 1, characterized in that the amount of ink applied to the board surface in step (S.1) is 6-8 g/m².

26. The method according to claim 1, characterized in that the amount of resin liquid applied in step (S.2) is 30-50 g/m².

27-35. (canceled)
